(19) United States
(12) Patent Application Publication
(10) Pub. No.: US 2010/0023779 A1
(43) Pub. Date: Jan. 28, 2010

(54) CRYPTOGRAPHIC PROCESSING METHOD AND CRYPTOGRAPHIC PROCESSING APPARATUS

(76) Inventor: Atsushi TORAI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/937,897

(22) Filed: Nov. 9, 2007

(30) Foreign Application Priority Data
Dec. 15, 2006 (JP) JP2006-337864

(51) Int. Cl. H04L 9/28

(52) U.S. Cl. 713/189

(57) ABSTRACT

In a cryptographic processing method, middle data which is the result of operation at a predetermined stage during encryption and decryption processing is saved and the subsequent encryption and decryption processes are divided into a first encryption and decryption processing which uses the initial data as input for the initial operation and second encryption and decryption processing which uses the saved middle data as input for the first stage operation.

### RELATED APPLICATION

This application is based on Japanese Patent Applications No. 2006-337864 filed with Japanese Patent Office on Dec. 15, 2006, the content of which is incorporated herein by reference.

### FIELD OF THE INVENTION

The present invention relates to a cryptographic processing method and a cryptographic processing apparatus for performing encryption or decryption of plain text.

### BACKGROUND OF THE INVENTION

Generally, data encryption with strong security and which is capable of high speed processing is desired.

Mainstream data encryption systems are moving away from DES (Data Encryption Standard) and toward AES (Advance Encryption Standard) and encryption strength is increasing. In addition, the AES encryption system has a number of modes which can be selected based on purpose and method of use.

For example, FIG. 6 shows an example of the configuration of an OFB (Output Feedback) mode encryption circuit 80. The encryption circuit 80 comprises: an AES encryption operation section 81 which performs a predetermined operation on an input value and outputs an encryption vector; a key register 82 which holds the encryption key input in the AES encryption operation section 81; an IV (initial vector) register 83 which holds the initial encryption vector (initial vector) input in the AES encryption operation section 81; a selector 84 which selects either of the encryption vector output as the result of the operation in AES encryption operation section 81 and the initial vector stored in the IV register 83 and assigns it to be input to the AES encryption operation section 81; an input register 85 for holding data to be encrypted or decrypted; an EXOR operation section 86 for exclusive-or summing of the output from the input register 85 and the output from the AES encryption operation section 81; and an output register 87 for holding the output from the EXOR operation section 86 (the data created as a result of encryption or decryption).

In the first stage of the encryption and decryption process, the encryption key that is held in the key register 82 and the initial vector IV that is held in the IV register 83 are input in the AES encryption operation section 81, and the AES encryption operation section 81 outputs the encryption vector as the results of the operation. The EXOR operation section 86 performs exclusive-or operation for the encryption vector and data to be encrypted or decrypted that is held in the input register 85, and the results are held in the output register 87 as the data resulting from the encryption or decryption.

In the subsequent stages, the encryption vector that was output from AES encryption operation section 81 in the previous stage is returned to being input in the AES encryption operation section 81, and the AES encryption operation section 81 inputs the encryption vector as well as the encryption key that is held in the key register 82 and performs the operations. The EXOR operation section 86 performs exclusive-or operation for the encryption vector which is the operation result output by the AES encryption operation section 81 and the data for encryption or decryption that is held in the input register 85, and the operation results are held in the output register 87 as encrypted or decrypted data.

FIG. 7 shows the encryption process at the encryption circuit 80; FIG. 8 shows the decryption process; and FIG. 9 shows the timing chart at the encryption process. The encryption process is used as an example in the following description. In the processing of the first stage P1, the AES encryption operation section 81 uses the initial vector IV and the encryption key as input and the encryption vector EV1 is output as the operation result. The EXOR operation section 86 takes the exclusive-or operation of the encryption vector EV1 and the plain text 1 held in the input register 85 and outputs the encrypted plain text 1. In the processing of the second stage P2, the AES encryption operation section 81 uses the encryption key and the encryption vector EV1 generated at the first stage as input and outputs the encryption vector EV2, and the EXOR operation section 86 takes the exclusive-or sum of the encryption vector EV2 and the plain text 2 and outputs encrypted plain text 2. In the processing of the second stage P3, the AES encryption operation section 81 uses the encryption key and the encryption vector EV2 generated at the previous stage (second stage) as input and outputs the encryption vector EV3, and the EXOR operation section 86 takes the exclusive-or operation of the encryption vector EV3 and the plain text 3 and outputs encrypted plain text 3. In the subsequent stages, the same operation is repeated.

In this type of encryption/decryption process, encryption/decryption of data of a fixed length (such as 128 bits) is performed at each stage and in order to process plain text or encrypted text having long bit length, many stages are processed in a time series and thus the processing time becomes long. An example of a technique for reducing the processing time for encryption is: computing only the necessary bit number in the case where the data length of the input data and the key length of the encryption block are not the same and thereby reduce the processing time for encryption/decryption for the streaming data and the like (Refer to Japanese Unexamined Patent Application Publication No. 2004-45641 for example.)

The above technique for reducing the process time assumes the special case of encryption in character units, but a useful technique for reducing processing time for generally available data without losing encryption strength is desired.

### SUMMARY OF THE INVENTION

The present invention was conceived in view of the above, and the object thereof is to provide a cryptographic processing method and a cryptographic processing apparatus capable of shortening the encryption/decryption processing time without losing encryption strength.

According to one aspect of the invention, a cryptographic processing method is provided. The cryptographic processing method comprises: performing first stage operation using inputted initial data; saving middle data which is a result of operation at a predetermined stage during encryption and decryption processing, wherein the encryption and decryption processing is for performing operations in subsequent stages to the first stage, returning middle data which is the operation result in each previous stage to input of each operation in the subsequent stages, and performing encryption or decryption of data that is subject to the encryption and decryption processing using the middle data which is the result of the operation at each stage; and performing the subsequent encryption and decryption processes by dividing them into a first encryption and decryption process which uses the initial data as input for the initial operation and a second encryption and decryption process which uses the saved middle data as input for the first stage operation.

According to another aspect of the present invention, a cryptographic processing method is provided. The method comprises: performing first stage operation using inputted initial vector and inputted encryption key; saving encryption vector which is a result of operation at a predetermined stage during encryption and decryption processing, wherein the encryption and decryption processing is for performing operations in subsequent stages to the first stage, returning the encryption key and encryption vector which is the operation result in each previous stage to input of each operation in the subsequent stages, and performing encryption or decryption of data that is subject to the encryption and decryption processing using the encryption key which is the result of the operation at each stage; and performing the subsequent encryption and decryption processes by dividing them into a first encryption and decryption process which uses the initial vector and the encryption key as input for the initial operation and a second encryption and decryption process which uses the encryption key and the saved encryption vector as input for the first stage operation.

According to yet another aspect of the present invention, a cryptographic processing apparatus is provided. The apparatus comprises: a first register for storing initial data; a first encryption and decryption processing section for performing first stage operation using the initial data stored in the first register, performing operations in stages subsequent to the first stage while returning middle data which is the operation result in each previous stage to input of each operation in the subsequent stages, and performing encryption or decryption of data that is subject to the encryption and decryption processing using the middle data which is the result of the operation at each stage; a second register for storing middle data which is a result of operation performed at a predetermined stage by the first encryption and decryption processing section; and a second encryption and decryption processing section for performing another first stage operation using the middle data stored in the second register as input, performing operations in stages subsequent to the another first stage while returning middle data which is the operation result in each previous stage to input of each operation in the subsequent stages, and performing encryption or decryption of data that is subject to the encryption and decryption processing using the middle data which is the result of the operation at each stage.

According to a further aspect of the present invention, a cryptographic processing apparatus is provided. The apparatus comprises: a first register for storing initial vector and encryption key; a first encryption and decryption processing section for performing first stage operation using the initial vector and the encryption key stored in the first register, performing operations in stages subsequent to the first stage while returning the encryption key and encryption vector which is the operation result in each previous stage to input of each operation in the subsequent stages, and performing encryption or decryption of data that is subject to the encryption and decryption processing using the encryption vector which is the result of the operation at each stage; a second register for storing encryption vector which is a result of operation performed at a predetermined stage by the first encryption and decryption processing section; and a second encryption and decryption processing section for performing another first stage operation using the encryption key and the middle data stored in the second register as input, performing operations in stages subsequent to the another first stage while returning the encryption key and encryption vector which is the operation result in each previous stage to input of each operation in the subsequent stages, and performing encryption or decryption of data that is subject to the encryption and decryption processing using the encryption vector which is the result of the operation at each stage.

### BRIEF DESCRIPTION OF THE DRAWINGS

FIG. 1 is a block diagram showing the components of the cryptographic processing apparatus of an embodiment of the present invention.

FIG. 2 is a flowchart showing the operation of the cryptographic processing apparatus of an embodiment of the present invention.

FIG. 3 is an explanatory diagram showing the parallel operation encryption process performed by the cryptographic processing apparatus 1 of an embodiment of the present invention.

FIG. 4 is an explanatory diagram showing the parallel operation encryption process performed by the cryptographic processing apparatus 1 of an embodiment of the present invention.

FIG. 5 is a waveform diagram showing the operation timing for the encryption process in the parallel operation performed by the cryptographic processing apparatus 10 of an embodiment of the present invention.

FIG. 6 is a block diagram showing an example of the configuration of the encryption circuit in the OFB mode of the prior art.

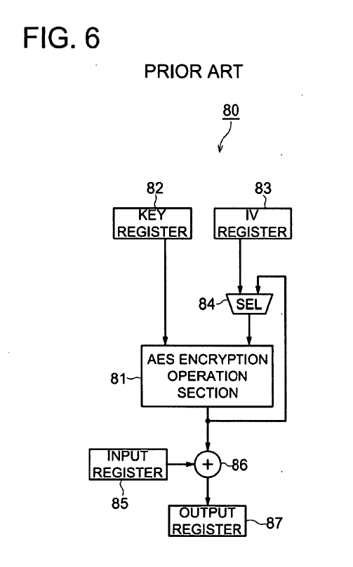

FIG. 7 is an explanatory diagram showing the encryption process in the encryption circuit shown in FIG. 6.

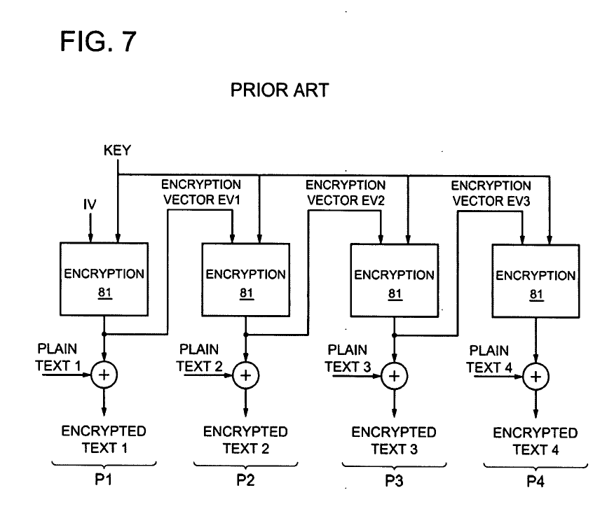

FIG. 8 is an explanatory diagram showing the decryption process in the encryption circuit shown in FIG. 6.

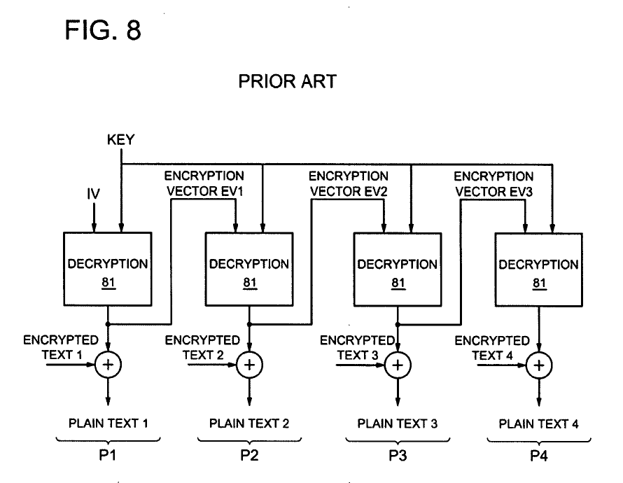

FIG. 9 is a waveform diagram showing the operation timing for the encryption process in the encryption circuit shown in FIG. 6.

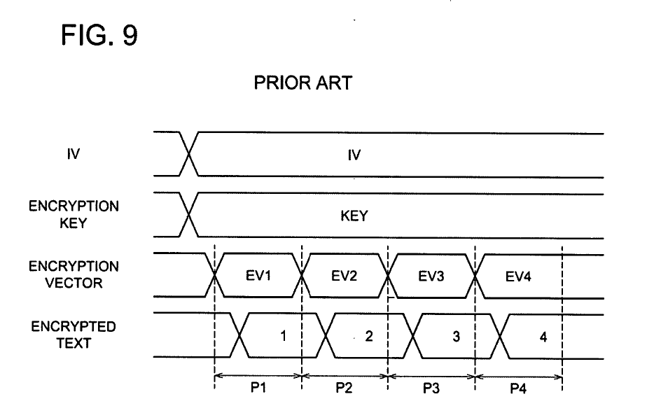

### DETAILED DESCRIPTION OF THE PREFERRED EMBODIMENTS

The following is a description of the embodiments of the present invention based on the drawings.

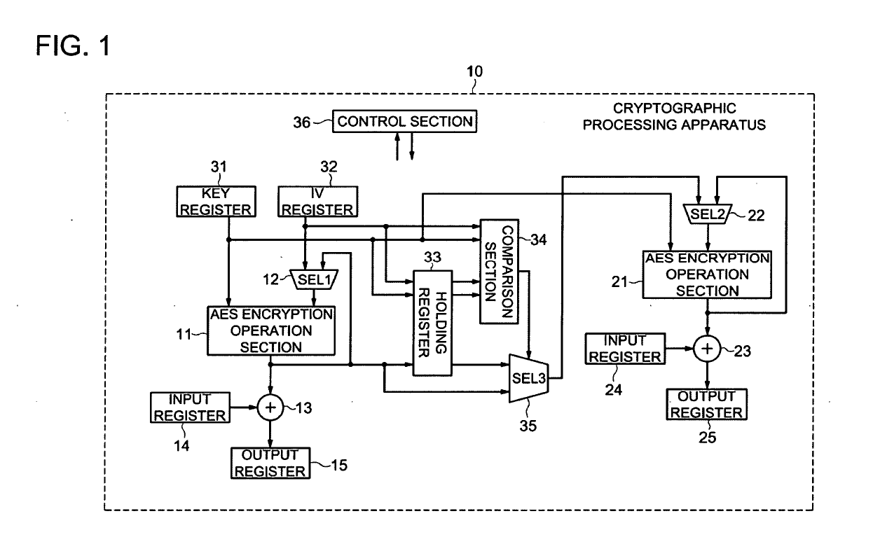

FIG. 1 shows the circuit configuration for the cryptographic processing apparatus 10 of an embodiment of the present invention. The cryptographic processing apparatus 10 comprises: a first AES encryption operation section 11 which is the first encryption and decryption processing section; a first selector 12; a first EXOR operation section 13; a first input register 14; a first output register 15; a second AES encryption operation section 21 which is the second encryption and decryption processing section; a second selector 22; a second EXOR operation section 23; a second input register 24; a second output register 25; as well as a key register 31; an IV register 32; a holding register 33; a comparison section 34; a third selector 35; and a controller 36 which controls all the operations.

The first AES encryption operation section 11 and the second AES encryption operation section 21 are circuits which perform predetermined block encryption operation based on the AES standards, and output the encryption vector as the operation results. The key register 31 is the register for holding the encryption key and the encryption key held in the key register 31 is input into the first AES encryption operation section 11 and the second AES encryption operation section 21. The IV register 32 is a register for holding suitably selected data which will become the initial vector IV to be input into the first AES encryption operation section 11.

The first selector 12 selectively outputs either of the initial vector IV held in the IV register 32 and the encryption vector output as the operation result to the first AES encryption operation section 11. Control is performed such that in the first stage operations, the first selector 12 selects the initial vector IV held in the IV register 32 and in the subsequent operations, the encryption vector which is the operation result from the previous stage that is output from the first AES encryption operation section 11 is selected.

The first input register 14 is a register which holds data for encryption or decryption using the encryption vector output from the first AES encryption operation section 11. The first EXOR operation section 13 computes the exclusive-or sum of the data output from the first input register 14 and the encryption data output from the first AES encryption operation section 11. The first output register 15 is the register for holding the operation results from the first EXOR operation section 13.

The holding register 33 holds the encryption key output form the key register 31; the initial vector IV output from the IV register 32; and the encryption vector output from the first AES encryption operation section 11. It is to be noted that the encryption vector held in the holding register 33 is called the middle encryption vector. The comparison section 34 compares the encryption key output from the key register 31 with the encryption key held in the holding register 33, and also compares the initial vector IV output from the register 32 with the middle encryption vector held in the holding register 33 and then outputs the results of the comparisons. More specifically, genuine or non-genuine determination is done based on conditions that the encryption key output from the key register 31 and the encryption key output from the holding register 33 are the same and the initial vector IV output from the register 32 and the middle encryption vector output from the holding register 33 are the same.

The third selector 35 selectively outputs the middle encryption vector that is stored in the holding register 33 when the comparison results from the comparison section 34 are genuine, and selectively outputs the encryption vector output from the first AES encryption operation section 11 when they are non-genuine.

The second selector 22 performs the function of selectively outputting either of the output from the third selector 35 and the encryption vector output as the operation result of the second AES encryption operation section 21 to the second AES encryption operation section 21. The second selector 22 is controlled to select the output from the third selector 35 in the first stage operation in the second AES encryption operation section 21, and in the subsequent operations, to select the encryption vector which is the operation result from the previous stage output from the second AES encryption operation section 21.

The second input register 24 is a register which holds data for encryption or decryption using the encryption vector output from the second AES encryption operation section 21. The second EXOR operation section 23 computes the exclusive-or operation of the data output from the second input register 24 and the encryption vector output from the second AES encryption operation section 21. The second output register 25 is the register for holding the operation results from the second EXOR operation section 23.

The control section 36 performs the function of controlling the operation sequence for the cryptographic processing apparatus 10, and controls, for example, switching between the first selector 12 and the second selector 22 and the holding timing of the holding register 33.

The set of the data to the key register 31 and the IV register 32; the set for the first input register 14 and the second input register 24 of the data to be subjected to cryptographic processing; the reading of the encrypted or decrypted data from the first output register 15 and the second output register 25 are performed in the upper processing section of the cryptographic processing apparatus 10. In addition, the cryptographic processing apparatus 10 communicates the comparison results at the comparison section 34 to the upper processing section.

Next, the encryption/decryption operation using the cryptographic processing apparatus 10 will be described.

In the first encryption and decryption processing section and the second encryption and decryption processing section of the cryptographic processing apparatus 10, if the input initial values (encryption vector and encryption key) are the same, encryption vector for the Nth operation result will always be the same. Thus, when the 2N stage cryptographic processing is carried out, the encryption vector for the Nth operation results and the encryption key at that time, as well as the initial vector IV are stored in the holding register 33 and in the subsequent encryption and decryption processing, processing from the first processing to the Nth processing is performed in the first encryption and decryption processing section with the encryption key and the initial vector IV as the initial values under the conditions that the encryption key set in the key register 31 and the initial vector IV set in the IV register 32 are equal to the encryption key and the initial vector held in the holding register 33. Processing from the N+1th to the 2Nth stage is performed in parallel in the second encryption and decryption processing section with the previous encryption key and the middle encryption vector held in the holding register 33 as the initial values. This operation is described in detail in the following.

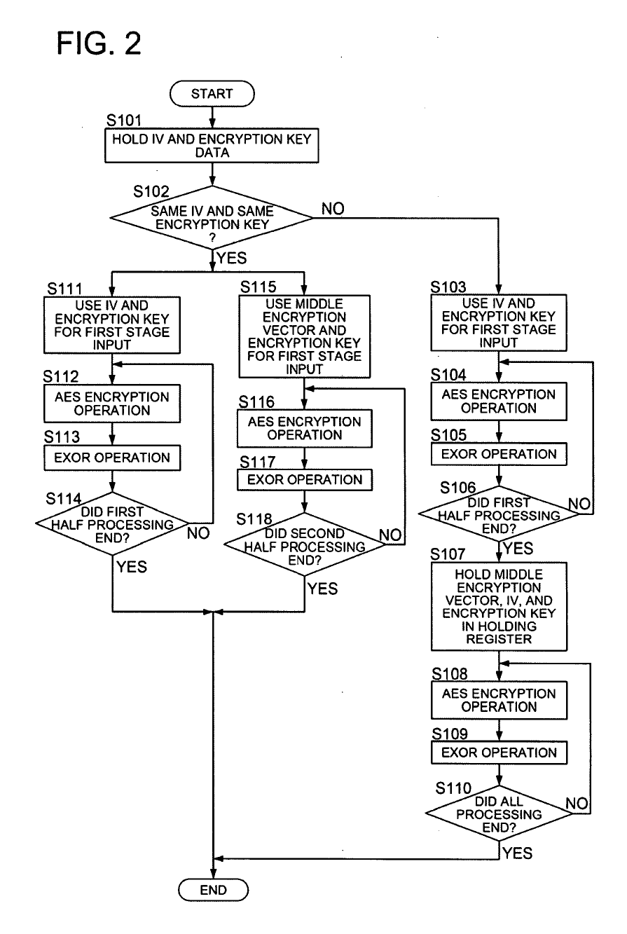

FIG. 2 shows the flow of the operations of the cryptographic processing apparatus 10. First, the encryption key is set from an external processing section to the key register 31 and the initial vector IV is set to the IV register 32 is performed (Step S101). Subsequently, when a start up command is received from the processing section, the comparison section 34 in the encryption processing apparatus 10 checks whether the encryption key held in the key register 31 and the initial vector IV held in the IV register 32 are the same as the encryption key held in the holding register 33 and the initial vector also held in the holding register 33 (Step S102).

In the case where the encryption key held in the key register 31 and the encryption key held in the holding register 33 are not equal or in the case where the initial vector IV held in the IV register 32 and the initial vector IV held in the holding register 33 are not equal (Step S102: N), the cryptographic processing apparatus 10 notifies the processing section of the fact that the current cryptographic process is a normal operation. In addition, the output from the IV register 32 is selected by the first selector 12 and the encryption key held in the key register 31 and the initial vector IV held in the IV register 32 are input in the first AES encryption operation section 11 (Step S103).

It is to be noted that the processing section that has received the notification of normal operation, sets sequential data in the first input register 14 for the first half of the data to be processed and also sequentially reads out data that has been subjected to encryption or decryption processing from the first register 15. In addition, after processing of the first half ends, the second half of the data to be processed is set sequentially in the second input register 24 and encrypted or decrypted data is sequentially read from the second output register 25.

In the state where the encryption key held in the key register 31 and the initial vector IV held in the IV register 32 are input, the first AES encryption operation section 11 performs the first stage operations (Step S104) and the first EXOR operation section 13 computes the exclusive-or operation of the encryption vector output from the first AES encryption operation section 11 as the operation results and the data to be encrypted or decrypted that is held in the first input register 14 (Step S105). The output of the operation results of the first EXOR operation section 13 is held in the first output register 15, and read out by the processing section.

In the subsequent stages, the first selector 12 is switched and the encryption vector output from the first AES encryption operation section 11 in the previous operation and the encryption key that is held in the key register 31 are input into the first AES encryption operation section 11 and then the same process is repeated (Step 106: N, S104, S105).

It is to be noted that in each step, encryption or decryption processing is performed for a predetermined number of bits (for example 128 bits). By repeating the processing a number of times, data with long bit length can be processed.

In this manner, when encryption or decryption of the data for processing from the top to the first half ends (Step S106: Y), the encryption vector output from the first AES encryption operation section 11 at that point is input into the second AES encryption operation section 21 via the second selector 22. At the same time, the encryption vector output from the first AES encryption operation section 11, the encryption key output from the key register 31 and the initial vector IV output from the IV register 32 are held in the holding register 33 (Step 107).

The second AES encryption operation section 21 uses the encryption vector for the first half to the end output from the first AES encryption operation section 11 and the encryption key held in the key register 31 as input and performs the operation (Step 108), and the second EXOR operation section 23 performs exclusive-or operation for the encryption vector output from the second AES encryption operation section 21 and the data for encryption or decryption stored in the second input register 24 (Step 109). The output of the operation results for the second EXOR operation section 23 are held in the second register 25 and read out by the processing section.

In the subsequent stages, the selector 22 is switched and the encryption vector output from the second AES encryption operation section 21 in the operation at the previous stage and the encryption key held in the key register 31 are input into the second AES encryption operation section 21 and the same process is repeated (Step S110: N, S108, S109). In addition, when the encryption or decryption processing for all of the data to be processed ends (Step S110: Y), all processing ends (END).

When results of the comparison at the comparison section 34 indicate that the encryption key held in the key register 31 and the encryption key held in the holding register 33 are the same and the initial vector IV held in the IV register 32 and the initial vector held in the holding register 33 are the same (Step S102: Y), the encryption processing section 10 notifies the processing section that the current encryption and decryption processing operate in parallel.

In addition, the selector 12 selects output from the IV register 32 and the encryption key held in the key register 31 and the initial vector IV held in the IV register 32 are input in the first AES encryption operation section 11 (Step S111). At the same time, third selector 35 is switched so as to select the middle encryption vector held in the holding register 33 and the second selector 22 is switched so as to select the output of the third selector 35. As a result, the encryption key held in the key register 31 and the middle encryption vector held in the holding register 33 are input in the second AES encryption operation section 21 (Step S115).

It is to be noted that when notification of parallel operation is received, the processing section performs the operation of sequentially setting the first half of the data for processing to the first input register 14 and sequentially reading the processed data that has been encrypted or decrypted from the first output register 15 in parallel with the operation of sequentially setting the second half of the data to be processed to the second input register 24 and sequentially reading the processed data that has been encrypted or decrypted from the second output register 25.

The first AES encryption operation section 11 performs the first stage operations in the state where the encryption key held in the key register 31 and the initial vector IV held in the IV register 32 are input (Step S112) and the first EXOR operation section 13 performs exclusive-or operation of the encryption vector output from the first AES encryption operation section 11 and the data for encryption or decryption stored in the first input register 14 (Step 113) and the operation results are held in the first register 25 and read out by the processing section. In the subsequent stages, the first selector 12 is switched and the encryption vector output from the first AES encryption operation section 11 in the operation of the previous stage and the encryption key held in the key register 31 are input in the first AES encryption operation section 11 and the same process is repeated until the first half of the data for processing ends (Step S114: N, S112, S113).

The following operation is performed at the second AES encryption operation section 21 side in parallel with the above operation. The second AES encryption operation section 21 performs the first stage operations in the state where the encryption key held in the key register 31 and the middle encryption vector held in the holding register 33 are input (Step S116), and second EXOR operation section 23 computes the exclusive-or operation of the encryption vector output from the second AES encryption operation section 21 and the data to be encrypted or decrypted that is held in the second input register 24 (Step S117) and the second output register 25 holds the operation results.

In the subsequent stages, the second selector 22 is switched and the encryption vector output from the second AES encryption operation section 21 in the previous stage and the encryption key held in the key register 31 is input in the second AES encryption operation section and the same operation is repeated until the second half of the data for processing (Step S118: N, S116, S117).

In this manner, the processing for the first half of the data to be processed and processing of the second half is done in parallel and when both processes end, the entire process ends (END).

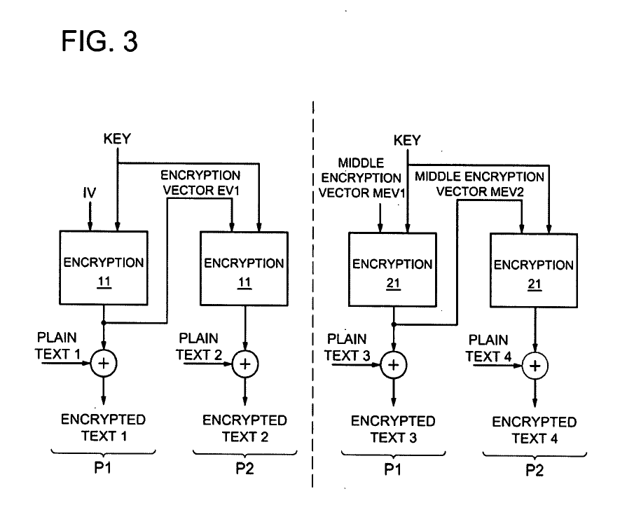

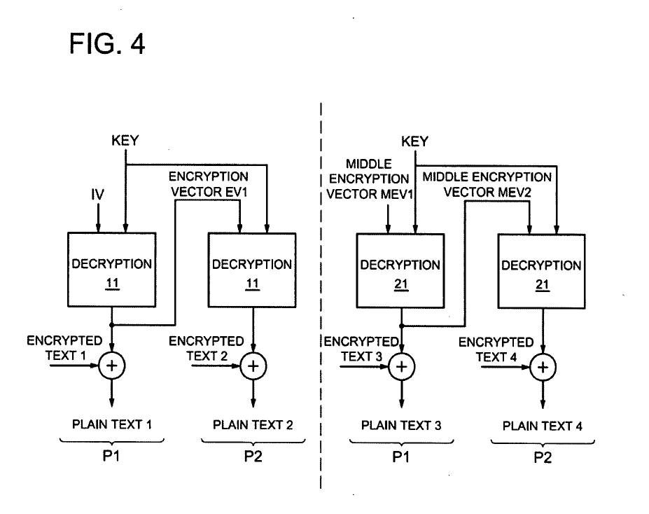

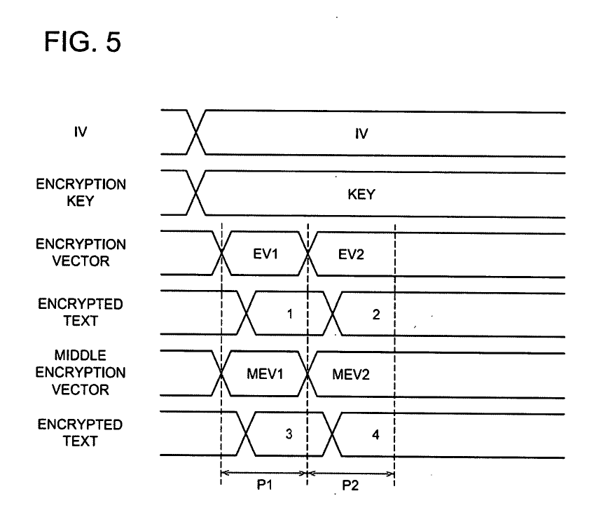

FIG. 3 shows the encryption process in parallel operation; FIG. 4 shows the decryption process in parallel operation; and FIG. 5 shows the timing chart of the encryption process in parallel operation. In this example, the data to be processed comprises plain text 1 to plain text 4. The encryption key (KEY) and the initial vector IV are input into the first AES encryption operation section 11 and the encryption key (KEY) and the middle encryption vector (MEV1) are input into the second AES encryption operation section.

In the parallel operation encryption process, the plain text 1 and the plain text 2 of the first half are sequentially encrypted at the first AES encryption operation section 11, and in parallel with this, the plain text 3 and the plain text 4 of the second half are sequentially encrypted at the second AES encryption operation section 21. For this reason, while the normal operation time for four stages used to be required, the entire operation ends in the operation time for two stages which are the first stage P1 and the second stage P2.

Similarly, in the parallel operation decryption process, the encrypted text 1 and the encrypted text 2 of the first half are sequentially processed at the first AES encryption operation section 11 side, and in parallel with this, the encrypted text 3 and the encrypted text 4 of the second half are sequentially decrypted at the second AES encryption operation section 21. For this reason, while the normal operation time for four stages used to be required, the entire operation ends in the operation time for two stages which are the first stage P1 and the second stage P2.

In this manner, by holding the encryption key, the initial vector IV and the middle encryption vector in the holding register 33, in the subsequent cryptographic processing, in the case where the encryption key held in the key register 31 and the initial vector IV held in the IV register 32 are the same as those held in the holding register 33, the middle encryption vector held in the holding register 33 is used and encryption and decryption of the second half is performed in parallel with processing for the first half and thus, the overall processing time is reduced to approximately half of that of normal operation.

In particular, in the image processing device such as the copier or multifunction peripheral, when images for a plurality of pages are encrypted or decrypted, if the same encryption key and initial vector IV are used for the plurality of pages, the middle encryption vector can be used for the plurality of pages and encryption and decryption of the data can be performed by parallel operation and the processing time for encryption and decryption can be reduced. For example, the first page is encrypted using the normal operation and before that ends, the middle encryption vector is held. The second page and chose after use the middle encryption vector that was held to perform parallel operation encryption. Furthermore, after encryption in the copy operation, decryption is done immediately and thus, the middle encryption vector from the first page can be used in the decryption process and parallel operation also becomes possible.

In the above, embodiments of the present invention have been described using drawings, but the specific structure is not limited to those shown in the embodiments, and various modifications and additions are included in the present invention provided that they do not depart from the spirit of the invention.

For example, in these embodiments, in the parallel operation, the data to be processed is divided into halves to optimize the processing, but even in the case where the data is not evenly divided, the effect of reduced processing time can be obtained in accordance with how the data is divided and even division is not necessarily required.

In addition, in these embodiments, there are two cryptographic processing sections and these operate in parallel, but there may be more cryptographic processing sections such as three, four, eight, and the like, which operate in parallel. For example, in the case where there are four cryptographic processing sections, the encryption vector at the point when processing of ¼ of the data to be processed ends, the encryption vector at the point when 2/4 of the data ends, and the encryption vector at the point when ¾ of the data ends are held and then if these three encryption vectors that are held and the initial vector IV are used and parallel operation is performed in four cryptographic processing sections, the processing time will be reduced to a quarter of that for normal operation.

Furthermore, in these embodiments, the middle encryption vector held in the holding register 33 is used to perform parallel operation under the conditions that the encryption key held in the key register 31 and the encryption key held in the holding register 33 are the same, and the initial vector IV held in initial IV and the initial vector held in the holding register 33 are the same. However, in the case for example, where it is known in advance that the encryption key and the initial vector are fixed and do not change, the middle encryption vector may be used for performing parallel operation without confirming the above conditions.

In addition, in these embodiments, in the case of normal operation, the second AES encryption operation section 21 is used to process the second half, but the configuration may also be such that the second half is also processed by the first AES encryption operation section 11.

Also, the AES encryption operation section may be any operation section that performs other kinds of operations provided that output is uniquely set for the input. Input to the operation section is not limited to the set including the encryption key and the initial vector IV or the encryption vector and for example, and the operation section may be one in which, in the first stage, the initial data is input and computed, and in the subsequent stages, the middle data of the operation results for and the operations performed. In this case, the key register 31 and the IV register 32 may be replaced with an initial register for holding the initial data and the holding register 33 hold the initial data and the middle data. In addition, the comparison section 34 may compare the initial data held in the initial register and the values held in the holding register 33.

In the cryptographic processing method described above, middle data which is the result of operation at a predetermined stage during encryption and decryption processing is saved and the subsequent encryption and decryption processes are divided into a first encryption and decryption processing which uses the initial data as input for the initial operation and second encryption and decryption processing which uses the saved middle data as input for the first stage operation.

In the above operations, if the input initial data are the same, the Nth operation results will always be the same. For example, if the middle data for the mth stage operation result is held, by inputting this middle data as the initial value for operation, the same operation as the m+1th operation can be performed in the first stage operation. Thus, by performing the first stage operation from the first encryption and decryption processing, and performing the operation equivalent to the m+1 th stage which is separate from this, and is the second encryption and decryption processing as the first stage operation, these operations are performed in parallel and thus the overall processing time can be reduced.

In the other cryptographic process described above, the encryption vector which is the result of operation at a predetermined stage during the encryption and decryption process is saved and the subsequent encryption and decryption processes are divided into a first encryption and decryption process which uses the initial vector and the encryption key as input for the initial operation and a second encryption and decryption process which uses the encryption key and the saved middle vector as input for the first stage operation.

If the input initial vector and the encryption key are the same, the encryption vector for the nth operation results will always be the same. For example, if the encryption vector for the mth stage operation result is saved, by inputting this encryption vector and the previous encryption key as the initial value for operation, the same operation as the m+1th operation can be performed in the first stage operation. Thus, by performing the first stage operation in the first encryption and decryption processing, and performing the operation equivalent to the m+1 th stage which is separate from this, in the second encryption and decryption processing as the first stage operation, these operations are performed in parallel and thus the overall processing time can be reduced.

In the cryptographic processing apparatus described above, the first encryption and decryption processing section operates using the initial data stored in the first register as initial input and the second encryption and decryption processing section operates using the middle data stored in the second register as initial input. In the operations, if the input initial data are the same, the Nth operation results will always be the same. For example, if the middle data for the mth stage operation result is saved, the second encryption and decryption processing section which inputs this middle data as the initial value for operation performs the same operation as the m+1th operation at the first encryption and decryption processing section as the first stage operation. Thus, by the first encryption and decryption processing section performing the first stage operation and the second encryption and decryption processing section performing the operation equivalent to the m+1 th stage which is separate from this, these operations are performed in parallel and the overall processing time can be reduced.

In the other cryptographic processing apparatus described above, the first encryption and decryption processing section operates using the initial vector stored in the first register as initial input and the second encryption and decryption processing section operates using the previous encryption key and the middle vector stored in the second register as initial input. In the operations, if the input initial vector is the same as the encryption key, the Nth operation results will always be the same. For example, if the encryption vector for the operation result of the mth stage is held in the second register, the second encryption and decryption processing section in which the encryption vector is input as the initial value for operation performs the same operation as the m+1th operation at the first encryption and decryption processing section at the first stage operation. Thus, by the first encryption and decryption processing section performing the first stage operation and the second encryption and decryption processing section performing the operation equivalent to the m+1th stage which is separate from this, these operations are performed in parallel and the overall processing time can be reduced.

What is claimed is:

1. A cryptographic processing method comprising:
performing first stage operation using inputted initial data;
saving middle data which is a result of operation at a predetermined stage during encryption and decryption processing, wherein the encryption and decryption processing is for performing operations in subsequent stages to the first stage, returning middle data which is the operation result in each previous stage to input of each operation in the subsequent stages, and performing encryption or decryption of data that is subject to the encryption and decryption processing using the middle data which is the result of the operation at each stage; and
performing the subsequent encryption and decryption processes by dividing them into a first encryption and decryption process which uses the initial data as input for the initial operation and a second encryption and decryption process which uses the saved middle data as input for the first stage operation.

2. The cryptographic processing method of claim 1, further comprising;
saving the initial data together with the saved middle data,
wherein the subsequent encryption and decryption processes divided into the first encryption and decryption process and the second encryption and decryption process are performed under a condition of coincidence of the saved initial data with the initial data given to each subsequent encryption and decryption process of the subsequent encryption and decryption processes.

3. The cryptographic processing method of claim 1, wherein when a plurality of pages are to be encrypted or decrypted, the same initial data is used for each page of the plurality of pages.

4. A cryptographic processing method comprising:
performing first stage operation using inputted initial vector and inputted encryption key;
saving encryption vector which is a result of operation at a predetermined stage during encryption and decryption processing, wherein the encryption and decryption processing is for performing operations in subsequent stages to the first stage, returning the encryption key and encryption vector which is the operation result in each previous stage to input of each operation in the subsequent stages, and performing encryption or decryption of data that is subject to the encryption and decryption processing using the encryption key which is the result of the operation at each stage; and
performing the subsequent encryption and decryption processes by dividing them into a first encryption and decryption process which uses the initial vector and the encryption key as input for the initial operation and a second encryption and decryption process which uses the encryption key and the saved encryption vector as input for the first stage operation.

5. The cryptographic processing method of claim 4, further comprising;
saving the initial vector together with the encryption vector which is the result of operation at the predetermined stage,
wherein the subsequent encryption and decryption processes divided into the first encryption and decryption process and the second encryption and decryption process are performed under a condition of coincidence of the saved initial vector and encryption key with the initial vector and encryption key given to each subsequent encryption and decryption process of the subsequent encryption and decryption processes.

6. The cryptographic processing method of claim 4, wherein when a plurality of pages are to be encrypted or decrypted, the same initial vector and encryption key are used for each page of the plurality of pages.

7. The cryptographic processing method of claim 4, wherein performing the first encryption and decryption process and the second encryption and decryption process in parallel.

8. A cryptographic processing apparatus comprising:
a first register for storing initial data;
a first encryption and decryption processing section for performing first stage operation using the initial data stored in the first register, performing operations in stages subsequent to the first stage while returning middle data which is the operation result in each previous stage to input of each operation in the subsequent stages, and performing encryption or decryption of data that is subject to the encryption and decryption processing using the middle data which is the result of the operation at each stage;
a second register for storing middle data which is a result of operation performed at a predetermined stage by the first encryption and decryption processing section; and
a second encryption and decryption processing section for performing another first stage operation using the middle data stored in the second register as input, performing operations in stages subsequent to the another first stage while returning middle data which is the operation result in each previous stage to input of each operation in the subsequent stages, and performing encryption or decryption of data that is subject to the encryption and decryption processing using the middle data which is the result of the operation at each stage.

9. The cryptographic processing apparatus of claim 8, wherein the second register further stores initial data inputted for the first stage operation when generating the middle data, the cryptographic processing apparatus further comprising: a comparison section for comparing the initial data stored in the first register with the initial data stored in the second register, wherein the second encryption and decryption processing section performs encryption or decryption under a condition of coincidence of the initial data stored in the first register and the initial data stored in the second register as a comparison result by the comparison section.

10. A cryptographic processing apparatus comprising:
a first register for storing initial vector and encryption key;
a first encryption and decryption processing section for performing first stage operation using the initial vector and the encryption key stored in the first register, performing operations in stages subsequent to the first stage while returning the encryption key and encryption vector which is the operation result in each previous stage to input of each operation in the subsequent stages, and performing encryption or decryption of data that is subject to the encryption and decryption processing using the encryption vector which is the result of the operation at each stage;
a second register for storing encryption vector which is a result of operation performed at a predetermined stage by the first encryption and decryption processing section; and
a second encryption and decryption processing section for performing another first stage operation using the encryption key and the middle data stored in the second register as input, performing operations in stages subsequent to the another first stage while returning the encryption key and encryption vector which is the operation result in each previous stage to input of each operation in the subsequent stages, and performing encryption or decryption of data that is subject to the encryption and decryption processing using the encryption vector which is the result of the operation at each stage.

11. The cryptographic processing apparatus of claim 10, wherein the second register further stores initial data inputted for the first stage operation when generating the encryption vector to be stored and encryption key, the cryptographic processing apparatus further comprising: a comparison section for comparing the initial vector and the encryption key stored in the first register with the initial vector and the encryption key stored in the second register, wherein the second encryption and decryption processing section performs encryption or decryption under a condition of coincidence of the initial vector and the encryption key stored in the first register and the initial vector and the encryption key stored in the second register as a comparison result by the comparison section.

12. The cryptographic processing apparatus of claim 8, wherein when the second encryption and decryption processing section performs encryption or decryption, the first encryption and decryption processing section and the second encryption and decryption processing section shares encryption or decryption of data that is subject to the encryption and decryption processing.

13. The cryptographic processing apparatus of claim 12, wherein the first encryption and decryption processing section and the second encryption and decryption processing section operate in parallel.
